(19) United States
(12) Patent Application Publication
(10) Pub. No.: US 2007/0145952 A1
(43) Pub. Date: Jun. 28, 2007

(54) Efficient power system

(75) Inventor: Antonio D. Arcena, Cative (PH)

Correspondence Address: NATH & ASSOCIATES, 112 South West Street, Alexandria, VA, 22314, US

(73) Assignee: Cogeneration Energy Corp., Temecula, CA (US)

(21) Appl. No.: 11/514,938

(22) Filed: Sep. 5, 2006

(30) Foreign Application Priority Data
Dec. 23, 2005 (PH) 1-2005-000620
Dec. 23, 2005 (PH) 1-2005-000621

(51) Int. Cl. H02J 7/00

(52) U.S. Cl. 320/135

(57) ABSTRACT

A power system and method make highly efficient use of power supplied from a utility to a facility. A 110-volt line will commonly supply between 107 to 120 volts. A power system couples energy from the utility to a load circuit and may interface with further sources to supply the load circuit. The power system limits output voltage circuit to a preselected nominal level, e.g., 107 volts. Energy provided by the utility which is embodied in voltage above the nominal level is diverted to a charging circuit to charge a storage circuit. On command, the storage circuit delivers input power coupled to a waveform generator which produces a mirror of the waveform of the utility voltage as a supplemental AC voltage. The supplemental voltage is provided to the facility circuit either in response to a user-generated control signal, an output level from the storage circuit or in response to load requirements.

### FIELD OF THE INVENTION

The present subject matter relates to efficient utilization of alternating current electrical power, and also using stored energy to reduce alternating current demand from a utility.

### BACKGROUND OF THE INVENTION

Energy conservation has long been a desirable objective. At the present time, many factors make energy conservation an extremely important objective. Many major metropolitan areas suffer “blackouts” or “brownouts” at times of peak demand. However, increasing power generation capacity is problematic. Large capital expense is required when increasing capacity. In addition, siting of a new power plant is difficult due to both environmental factors and the frequent opposition of communities near a proposed site. New power plants, once constructed, may produce undesirable byproducts such as greenhouse gases, coal ash or nuclear waste. Use of additional energy in many cases increases reliance on fossil fuel, which is increasing in price and decreasing in reliability of supply. Even when additional power is available, its use entails increased cost for domestic and industrial customers.

Many different techniques have been provided in the prior art for better utilization of electricity supplied by a utility, particularly with respect to loads drawing higher than average current. In the case of a hotel or office building, such a load could be an air conditioning system. Techniques for handling such high loads include computer-controlled disabling of air conditioning for a limited time during periods when other loads are drawing a peak current. Other techniques include providing circuits for more efficient use of electricity and circuits interfacing power from renewable energy sources to supplement power supplied by a commercial utility line. However, the prior art does not provide for continuous and relatively complete use of power supplied from a utility. As used herein, “utility” need not necessarily refer to a franchised commercial utility company, but may also refer to other types of power providers.

U.S. Pat. No. 6,680,547 discloses a power sharing system for powering a plurality of loads using line voltage and a rechargeable source. Each load can be coupled to either the line voltage or the rechargeable source by means of a power source selector switch coupled to each load. A programmable controller is coupled to each power source selector switch to control a position thereof to maximize usage of the rechargeable source based on power requirements of the loads. The utility supply and the rechargeable source are used alternately and do not interact to maximize efficiency in supplying a load.

U.S. Pat. No. 5,929,538 discloses a power processor which may be used as part of a hybrid electrical power source system which may contain a photovoltaic array, diesel engine, and battery power sources. Different power sources are combined to supply a load. However, interaction with utility power is not disclosed.

U.S. Pat. No. 5,892,664 discloses a system transferring electric power with variable voltage characteristics to a utility for co-generation purposes. Electric power whose voltage may vary, such as that produced by a wind generator, is converted to variable voltage direct current (DC) electric power. An inverter converts the variable voltage DC power to alternating current (AC) electric power of medium frequency and then matches the frequency and phase of AC voltage to that of a utility power grid. While this system interfaces power from renewable sources, no provision is made for processing voltage from a utility line for improving efficiency.

U.S. Pat. No. 4,140,959 discloses an electrical power generating system for supplementing an electrical power distribution network. The system of this invention includes electrical generation means adapted to be powered by a specific energy source and which develops electrical energy which is stored for intermittent or periodic transfer into the primary power system. However, no interaction with line current from the utility is shown, nor is the supplemental power used to decrease energy drawn from the utility for a given load.

U.S. Pat. No. 5,493,155 discloses a system for supplementing solar power with utility power. The system is not directed to maximizing efficiency of use of the utility power.

These prior art schemes do not examine an energy input waveform for portions of input power to determine whether input power may be regarded as excess power. They also do not provide load dependent response or response to battery level to determine a charging cycle.

A great deal of prior art for generating an AC waveform from stored energy has been developed with respect to uninterruptible power supplies. However, these circuits are intended to operate when line voltage is absent. They are not directed to minimizing power requirements during use of line current.

### SUMMARY OF THE INVENTION

Briefly stated, in accordance with embodiments of the present invention, an efficient power system and method for taking power received from a utility and providing power to a facility in which substantially complete use is made of the power supplied by the utility is provided. Generally, power supplied by a utility, referred to here as line current, will have a voltage that varies over time. For example, a nominal 110-volt line might supply between 105 volts and 120 volts at various times during a day. In an embodiment of the present invention, a nominal voltage level adequate to operate a facility load, e.g., 107 volts, is selected. The nominal voltage is selected as a threshold level for a diversion circuit. Energy embodied in line current above the threshold level is diverted by a diversion circuit to charge a storage circuit, while the facility load is operated at the nominal voltage. The charging circuit is coupled to supply power to a waveform generator which produces a mirror of the waveform of the utility voltage as a supplemental AC voltage. The supplemental voltage is then combined with line current so that the facility load is operated with reduced demand on the utility. For example, a lower level than 107 volts may be drawn from the line current, and the supplemental voltage may comprise the remainder of the 107 volts.

In one form, the storage circuit comprises batteries which are discharged only to a preselected depth prior to being uncoupled from the load for recharging. A charger supplied by the utility line may also be used to charge the batteries. Power generated from renewable energy sources may also be interfaced to the system.

### BRIEF DESCRIPTION OF THE DRAWINGS

The present subject matter may be further understood by reference to the following description taken in connection with the following drawings:

FIG. 1 is an illustration partially in block diagrammatic form of a nominal operating environment in which an embodiment of the present invention is utilized;

FIG. 2 is a block diagram illustrating an embodiment in a three phase power system;

FIG. 3 is a block diagram of an implementation of the system illustrated in FIG. 1;

FIG. 4 is a partial block diagram illustrating another embodiment;

FIG. 5 is a partial, detailed view of a power system illustrating one form of diversion circuit;

FIG. 6 is a block diagram illustrating one form of storage circuit;

FIG. 7 is a diagram partially in schematic and partially in block diagrammatic form illustrating a waveform generator and power distribution circuit;

FIG. 8 is a waveform chart useful in understanding operation of the diversion circuit;

FIG. 9 is a waveform chart useful in understanding operation of the waveform generator;

FIG. 10 is a chart illustrating a duty cycle for a waveform generator;

FIGS. 11 and 12 are illustrations of a control panel and a terminal panel in one embodiment; and

FIG. 13 is a block diagram illustrating a further embodiment.

### DETAILED DESCRIPTION

Embodiments of the present invention include a system and method for efficient use of power supplied from a utility to a load or loads in a facility. A utility will commonly comprise a commercial power company franchised to supply electricity. However, a utility will also include a source customarily comprising a main source of power for a facility. A facility may include a home, office or industrial building, or may include a combination of buildings.

Utilities provide power at a voltage approximating a rated line voltage. Each nation specifies a rating for line voltage. For example, in the United States, alternating current rated line voltage is 110 volts. Commonly, utilities may supply 105-120 volts to utility lines rated at 110 volts. Appliances and other items designed for use in the United States will operate satisfactorily when supplied at a nominal voltage level, 107 volts, for example. Therefore, the energy embodied in a portion of a power input sine wave above 107 volts is not necessary to operate those items. This additional energy may be characterized as essentially wasted by prior art systems. Some appliances may use a regulation circuit to dissipate excess energy to assure that when voltage exceeds the nominal level, only the nominal level is supplied. Embodiments of the present invention make use of the excess energy.

In employment of embodiments of the present invention, input voltage supplied by a utility is coupled to a facility including one or more electrical loads. The input voltage is monitored and regulated to be applied to loads at the nominal level. In the United States, where rated voltage level of single phase utility lines is 110 volts, a nominal voltage level may be selected to be 107 volts. The nominal voltage is selected as a threshold level. When input voltage exceeds the threshold, energy included in the portion of the input voltage waveform from the utility which is in excess of the nominal voltage level is diverted from delivery to the load. This “excess energy” is supplied instead to a storage circuit. In one form, the storage circuit comprises batteries. In a further form, the line voltage is used to operate a charger for the storage circuit. The storage circuit provides supplemental power to the load.

Supply of supplemental power may be initiated when the charge on the storage circuit reaches a predetermined level, such as a voltage indicative of full charge. The supplemental power may be decoupled from load circuits when output voltage reaches a second, lower predetermined level. A waveform generator is used to convert stored direct current (DC) energy to alternating current (AC) in phase with utility voltage. Additionally, sources of electricity from renewable energy sources such as wind and solar panels may be connected to an interface circuit to provide further supplemental energy. In addition, electricity generated by the system of the present invention which is in excess of load requirements may be coupled to the power grid and sold back to the utility.

Embodiments of the present invention also include various subcombinations of the entire system. These subcombinations include a circuit and method processing an input power waveform to provide a first portion of input power to supply loads at a nominal voltage and to store energy embodied in voltage in excess of the nominal voltage and supplement utility power. Another subcombination is in the provision of an arrangement in which the ratio of line current and supplemental power source varies while supplying a load.

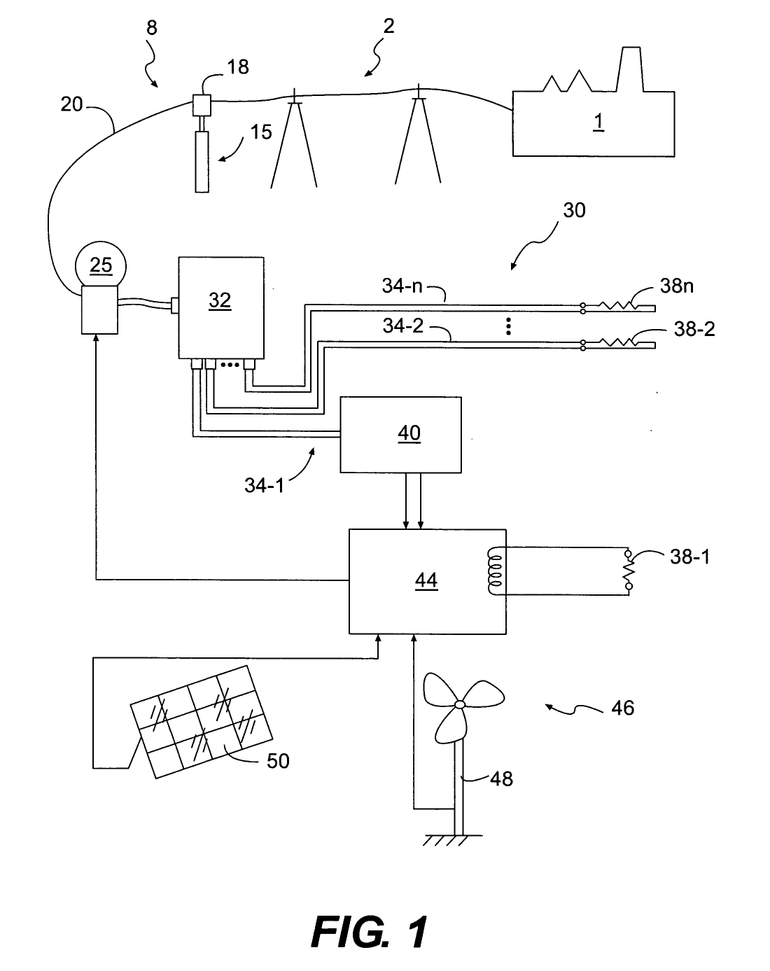

FIG. 1 is a diagram of a nominal operating environment in which an embodiment of the present invention is utilized. Power is generated by a utility 1 for transmission through a power grid 2 to users. The power grid 2 may comprise transmission lines, transformers, distribution substations and trunks. “Last mile” connections 8 are provided to couple power from the power grid 2 to a user's facility 30. The facility 30 is a home or office building or other utility customer. The alternating current power entering the facility 30 is referred to as line current since this term is commonly used in the art. The term line current is used irrespective of whether current is the parameter of greatest interest in the discussion.

The facility 30 is on a customer side of a final coupling means 15, coupling power from the utility grid 2 to the facility 30. In many residential applications, the final coupling means 15 includes a local transformer 18 on a power pole or below ground serving a group of facilities 30. One of a plurality of power drops 20 is connected from the local transformer 18 to a respective facility 30. At the interface of the power drop 20 and the facility 30, a meter 25 is provided. The meter 25 comprises means for measuring power supplied from the grid 2 to the facility 30. In many utility systems, users may sell power they generate to the utility 1. In these cases, the meter 25 also measures power supplied from the facility 30 to the grid 2. The meter 25 may further comprise a timer in applications in which the rates of the utility 1 vary with the time of day.

The facility 30 is coupled to the meter 25 by a terminal box 32. In many residential applications, the terminal box 32 is referred to as a circuit breaker box. Commonly, each of a plurality of facility circuits, collectively referred to as facility circuits 34, extends from the terminal box 32. In the present illustration, the facility circuits are denoted 34-1, 34-2, . . . 34-n. The facility circuits 34-1, 34-2, . . . 34-n supply power to load circuits 38-1, 38-2, . . . 38-n respectively. One or more load circuits 38-1 through 38-n may be collectively referred to as the load 38. In the present non-limiting illustration, the facility circuit 34-1 is connected to supply loads drawing the largest amount of power. Such loads may comprise a refrigerator, air conditioning unit, electric water heater, and clothes dryer. The circuits 34-2 through 34-n serve the other loads, such as wall outlets and light fixtures. In other applications, certain appliances, e.g., electric dryers, may be connected to a conventional two phase 220 volt circuit.

In the illustration of FIG. 1, a power system 40 constructed in accordance with an embodiment of the present invention is coupled to the facility 30 on the facility side of the meter 25. It is contemplated that the power system 40 could be interposed in other positions along the power path. However, it is generally preferable to have the power system 40 on the facility side of the meter. In the predominant number of applications, power entering the facility 30 will be paid for by the owner of the facility 30. Facilities 30 are generally individually metered. The meter 25 will register power drawn by the facility 30 and will provide credit to the facility 30 when power is supplied to the grid 2 by the facility 30. Alternatively, the power system 40 may be connected between the terminal box 32 and all facility circuits 34.

As part of a complete energy solution for a facility 30, the power system 40 may also comprise a distribution interface 44. The distribution interface 44 allows for coupling of additional energy sources 46, such as generators supplied by sources of renewable energy, to the facility 30 or the grid 2. The generators may comprise, for example, a windmill 48 and a solar panel unit 50. The distribution interface 44 may selectively couple energy to the facility 30 as well as to the grid 2 by way of the meter 25. In a further alternative scenario, a utility owner may place a power system 40 on the utility side of the meter 25 to regulate voltage supplied to the facility 30 and conserve energy prior to supplying electricity to the facility 30.

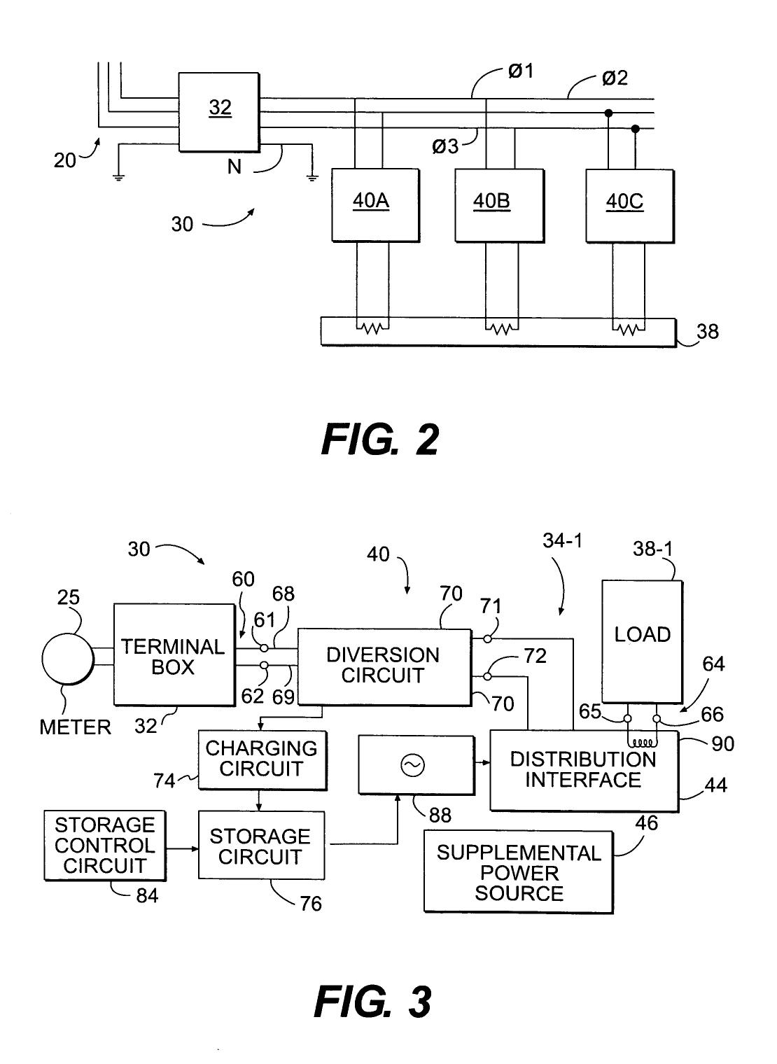

FIG. 2 is a block diagram illustrating an embodiment in a three-phase power system comprising first, second and third phases 01, 02 and 03, and a neutral line N, which is grounded. The load 38 in the present illustration comprises a three phase machine. Generally, industrial facilities 30 will be supplied by three-phase power lines, commonly power lines having three supply circuits and a neutral line. In the present illustration, first, second and third power systems 40A, 40B and 40C are provided for each phase of the input power. The first power system 40A is connected across lines Ø1 and Ø2. The second power system 40B is connected across lines Ø1 and Ø3. The third power system 40C is connected across lines Ø2 and Ø3. The three power systems 40A, 40B and 40C need not necessarily comprise discrete units or be housed in separate enclosures.

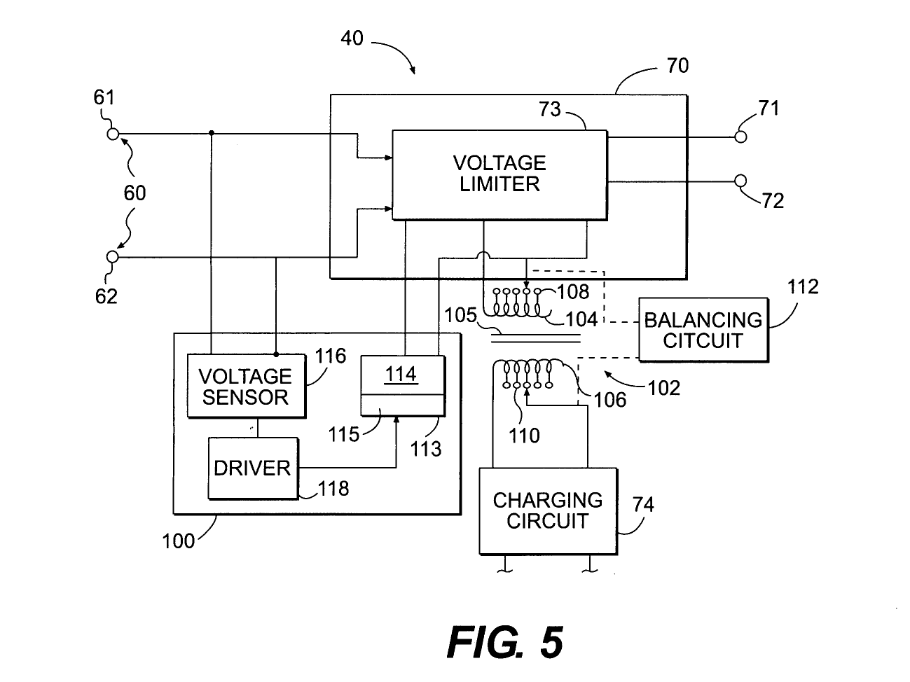

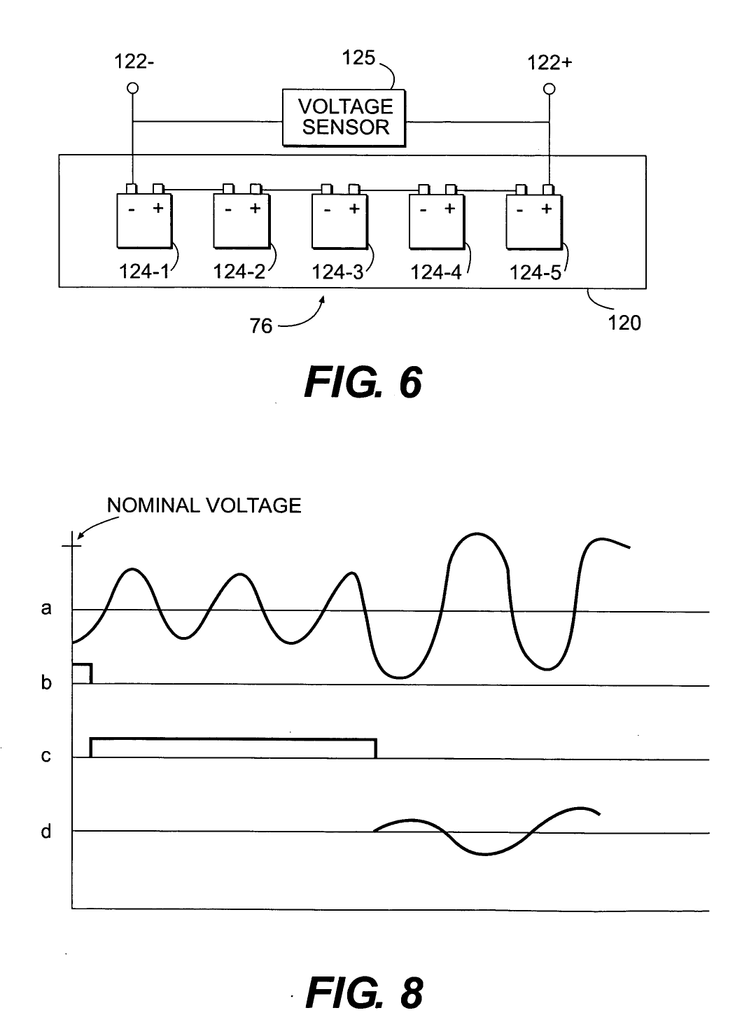

FIG. 3 is a block diagram of an implementation of the power system 40. A first terminal junction 60, including first and second input terminals 61 and 62, couples the power system 40 to receive input power from the terminal box 32. A second terminal junction 64, including first and second output terminals 65 and 66, couples the power system 40 to the load 38. A first power line 68 is coupled between the input terminal 61 and the first output terminal 65. A second power line 69 is coupled between the second input terminal 62 and the second output terminal 66. A diversion circuit 70 is coupled to respond to the level of line voltage across the first and second input terminals 61 and 62, which may be measured at points in the first and second power lines 69 and 69. To this end, the diversion circuit 70 may be connected across the first and second input terminals 61 and 62. The diversion circuit 70, described below with respect to FIG. 5, comprises a threshold circuit and a switch to further divert excess energy when the input voltage exceeds the threshold, or nominal, level. The diversion circuit 70 has output terminals 71 and 72 providing the nominal voltage. Energy is diverted from the line current by the diversion circuit 70 to a charging circuit 74 and stored in a storage circuit 76. The charging circuit 74 is connected to charge the storage circuit 76, which stores direct current energy. The charging circuit 74 includes a voltage regulator to supply a preselected charge level voltage. The charge level voltage is selected to match a desired voltage for the storage circuit 76. Most conveniently, the storage circuit 76 will comprise a battery or series of batteries, described further with respect to FIG. 6 below. However, supercapacitor circuits or other storage means could be utilized in the storage circuit 76.

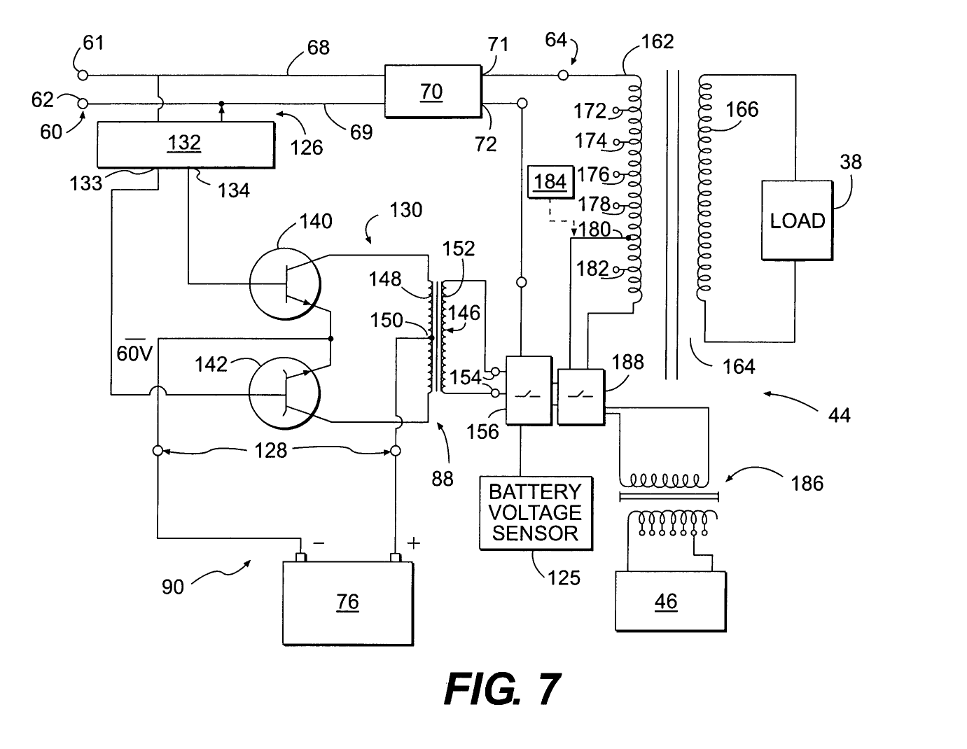

The storage circuit 76 provides direct current power to a waveform generator 88, which, as described with respect to FIG. 7 below, generates a waveform with phase and frequency matched to the line current. The waveform generator 88 provides voltage to the distribution interface 44. The distribution interface 44 includes sensing, regulating and power combining circuitry, described with respect to FIG. 7 below, to selectively combine power from the utility 1, the power system 40 and the additional sources 46. Power from the utility 1 is provided to the distribution interface 44 via the first and second output terminals 71 and 72 of the diversion circuit 70. The distribution interface 44 in the preferred form supplies the nominal voltage level to the output terminal junction 64 by adding voltage levels from each source currently in use. The waveform generator 88 and storage circuit 76 may be viewed as being included in a translation circuit 90. The translation circuit 90 takes DC power in and provides AC power synchronized with line current, as further described below with respect to FIG. 7.

A storage control circuit 84 selectively enables or disables a provision of supplemental power from the storage circuit 76 for combination with other power at the distribution interface 44, as further described below with respect to FIG. 7. The storage control circuit 84 may respond to commands, programmed instructions, control signals provided from a remote control or condition sensing. Supplemental power is supplied by a waveform generator 88 to mirror the shape of the input power wave. A matching transformer 90 is used to combine utility and supplemental voltage. The matching transformer 90 could, for example, combine utility power at a level of 70 volts with a supplemental power of 40 volts to provide a 110 volt output from the distribution interface 44.

In the present description, certain functions, such as switching or coupling, are each associated with a particular subsystem, e.g., the diversion circuit 70 or the waveform generator 88. However, components associated with certain functions may be embodied in different physical modules without affecting operation of the embodiments in a meaningful way. The subsystems are illustrated as separate components as a way to facilitate description. However, various components could be housed in a single enclosure or built into one or more integrated circuits.

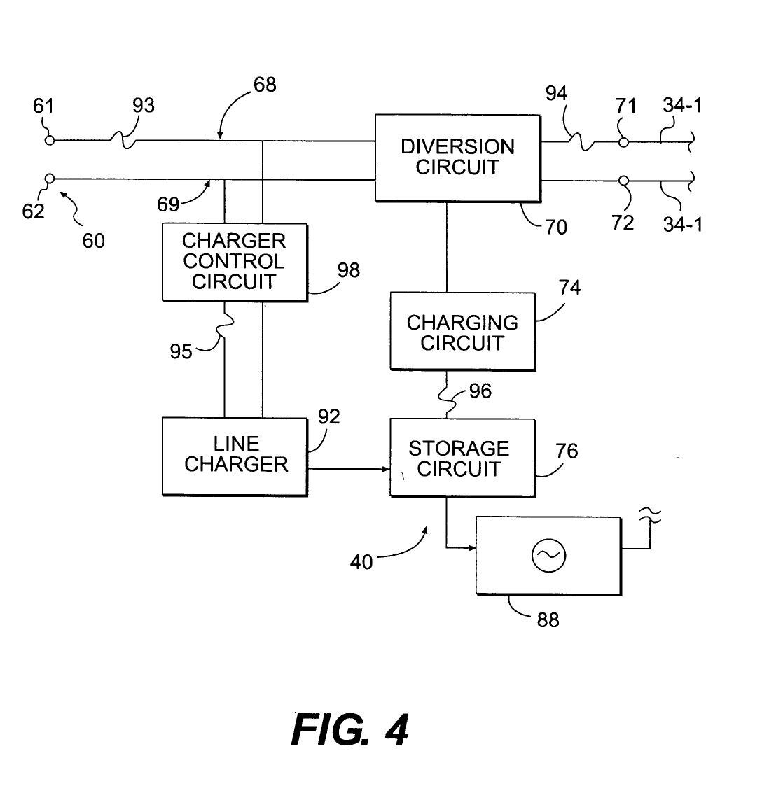

FIG. 4 is a partial block diagram illustrating a form of the power system 40 in which a conventional charger, referred to here as a line charger, is used in addition to the charging circuit 74. The input power is used selectively to charge the storage circuit 76 directly in addition to charging from the diversion circuit 70. To this end, in the embodiment of FIG. 4, a line charger 92 is provided coupled between the first terminal junction 60 and the storage circuit 76. In order to protect the power system 40 and facility circuits 34, the power line 68 includes a first circuit breaker 93 connected in series between the power system 40 and the input terminal 61. A second circuit breaker 94 is connected in the power line 68 between the power system 40 and the diversion circuit output terminal 71. Additionally, third and fourth circuit breakers 95 and 96 may be connected to an input of the line charger 92 and an input from the diversion circuit to the storage circuit 76 respectively.

A charger control circuit 98 connected across the power lines 68 and 69 controls switching of power lines 68 and 69 across the line charger 92. The line charger circuit 92 speeds charging of the storage circuit 76. Many different criteria may be used for enabling the line charger 92. The present embodiment is useful in conjunction with utilities whose rates are higher during peak hours, i.e., those hours of the day in which highest demand generally occurs, demand and lower during other hours, or off-peak hours, in which electric power demand is low. The charging circuit 76 may be charged when rates are lowest. The power system 40 may be operated to supply energy to the grid 2 at peak hours at which the facility 30 will be credited for power delivered to the grid 2 at a peak rate. The charger control circuit 98 may comprise timers programmed in correspondence with the times of day between which there are rate differentials. The charger control circuit 98 can be used to speed charging of the storage circuit 76 so that the storage circuit may initiate operation in a fully charged state when supplying the load 38.

FIG. 5 is a partial, detailed view of the power system 40 illustrating one form of the diversion circuit 70. The diversion circuit 70 comprises an input coupled across the first and second input terminals 61 and 62. The diversion circuit comprises a voltage limiter 73 to limit voltage coupled across the first and second diversion circuit output terminals 71 and 72 to the nominal voltage. The voltage limiter 73 may comprise a voltage regulator. When the line voltage is below the threshold, or nominal, voltage, the diversion circuit 70 does not couple energy to the charging circuit 74. The voltage limiter 73 limits voltage at the diversion circuit 70 output terminals 71 and 72 to the nominal voltage and supplies voltage in excess of the nominal voltage, or excess voltage, for coupling to the charging circuit 74. The diversion circuit 70 includes a bypass switch 100 which is operated as described below to couple or decouple the diversion circuit 70 to or from the charging circuit 74.

Energy is coupled to the charging circuit 74 by a transformer 102. Preferably, the transformer 102 is a matching transformer, i.e., a transformer with multiple taps on at least one winding. The transformer 102 has a primary winding 104, a secondary winding 106 and a core 105. The primary winding 104 has a plurality of taps 108, and the secondary winding 106 has a plurality of taps 110. The primary winding 104 is connected to receive line voltage in excess of the output level of the voltage limiter 73. As described below, the bypass control circuit 100 is operated to bypass the primary winding 104 when line voltage is not at least at the nominal level and to connect the primary winding to have voltage from the voltage limiter 73 in excess of the nominal voltage connected thereacross, or excess voltage. The secondary winding 106 is coupled to supply the charging circuit 74. The voltage across the primary winding 104 in excess of the threshold voltage will vary. Consequently, voltage available across the primary winding 104 for inducing voltage in the secondary winding will vary. It is therefore desirable to vary a ratio of the number of windings in the primary winding 104 to the number of windings in the secondary winding 106. A desired ratio may be determined in accordance with selected criteria. One criterion may be a ratio needed to maintain the voltage in the secondary winding 106 within a preselected range.

Connections to appropriate taps 108 and 110 on the primary and secondary winding 104 and 106 respectively are made by a balancing circuit 112. A first end of the primary winding 104 is coupled to the first input terminal 61. The balancing circuit has a first switching circuit connecting one of the taps 108 to the first output terminal 71. The secondary winding 106 has a first end connected to a first input of the charging circuit 74. The balancing circuit 112 contains a second switching circuit connecting one of the taps 110 to a second input of the charging circuit 74. The balancing circuit 112 comprises voltage sensing circuits to sense voltages across the primary and secondary windings 104 and 106. The balancing circuit 112 connects a preselected ratio of primary windings 104 to secondary windings 106 in correspondence with selected conditions. One significant condition is the ratio of voltage across the primary and secondary windings 104 and 106.

The bypass switch 100 comprises a controlled switch 113 having a controlled conductive path 114. One suitable form of controlled switch 113 is a triac since the controlled conductive path 114 in a triac will conduct alternating current. The controlled switch 113 is selectively turned on or off in response to a voltage at a control terminal 115. Selective switching of the controlled switch 113 is performed in response to line voltage. A voltage sensor 116 is connected to sense line voltage, and is preset to provide an output when the line voltage is at least at a preselected level. This preselected level may be selected to be the threshold level, which is 107 volts in the present illustration. When line voltage reaches the threshold level, the voltage sensor 116 produces an indicating signal. The indicating signal is coupled to a driver circuit 118 which applies a control signal to the control terminal 115 to turn off the controlled switch 113 and provide voltage across primary winding 104. Voltage is induced in the secondary winding 106 to supply the charging circuit 74. The voltage connected to the output terminal 65 (FIG. 3) is limited to the nominal voltage, which is 107 volts, and the remainder of input voltage is connected across the primary winding 104.

FIG. 6 is a schematic diagram of one form of storage circuit 76. The storage circuit 76 will supply a DC input to the waveform generator for conversion to AC as described with respect to FIG. 7 below. In the present illustration, the storage circuit 76 comprises a battery bank 120 having first and second terminals 122+ and 122−. The battery bank 120 comprises five batteries 124-1 through 124-5 connected in series. A battery voltage sensor 125, which may be included in the battery bank 120 or externally to the battery bank 120 is provided to monitor battery voltage. The batteries 124-1 through 124-5 may comprise car batteries, for example. Car batteries are suitable in that they are easily obtainable, and may have high current ratings. Where 12-volt batteries are utilized, five batteries in series will provide an output of 60 volts. Many different voltage levels may be used. Higher voltage battery banks 120 will store and provide a higher level of energy.

FIG. 7 is a diagram partially in schematic and partially in block diagrammatic form of the waveform generator 88 and the power distribution circuit 44. The waveform generator 88 provides an AC power waveform that will “mirror,” or duplicate, the frequency and phase of the line voltage. At an input terminal junction 126, the waveform generator 88 receives an input comprising the line voltage. DC power for conversion to AC power is provided from the storage circuit 76 at a power output terminal junction 128. In the present illustration, the storage circuit 76 comprises the battery bank 120 (FIG. 6). The direct current output from the storage circuit 76 is switched by a power switching circuit 130.

In the present illustration, the power switching circuit 130 comprises first and second switching transistors 140 and 142. The power switching circuit 130 may comprise an integrated circuit or discrete components. Each of the first and second switching transistors 140 and 142 has an emitter coupled to one terminal of the storage circuit 76 and a collector coupled to the other terminal of the storage circuit 76. A waveform sensor 132 is connected to the input terminal junction 126 to respond to the line voltage, and provides first and second outputs respectively to the bases of the first and second transistors 140 and 142. The collectors of the first and second transistors 140 and 142 are coupled to opposite ends of a primary winding 148 of an output transformer 146. The bases of the transistors 140 and 142 are connected to first and second output terminals 133 and 134 of the waveform sensor 132 respectively. As described below, the first and second transistors 140 and 142 will alternately connect opposite ends of the primary winding 148 to one terminal of the storage circuit 76. The primary winding 148 has a center tap 150. The center tap 150 is connected to the other terminal of the storage circuit 76. The output transformer 146 has a secondary winding 152. The secondary winding 152 provides waveform generator output power at a terminal junction 154.

Timing of the first and second outputs of the waveform sensor 132 corresponds respectively to timing of successive half cycles of the line voltage waveform. In one form, the first and second outputs are initiated in response to zero crossing of the line voltage waveform. Alternatively, maxima of the absolute values of the line voltage or inflection points could be sensed to detect the occurrence of successive half cycles. The waveform sensor 132 provides a switching bias to turn on the transistors 140 and 142 during respective half cycles of the input waveform. During a first half cycle, the transistor 140 emitter-collector circuit is closed. Voltage in the primary winding 148 flows in a first direction, and primary winding voltage is of a first polarity. In a next half cycle, the first transistor 140 turns off, and the emitter-collector circuit of the second transistor 142 is closed. Consequently, voltage flows in an opposite direction through the primary winding 148, and polarity of the voltage in the primary winding 148 is reversed. An AC waveform is generated, and AC voltage is induced in the secondary winding 152.

When the translation circuit 90 provides power, the secondary output winding 152 of the output transformer 146 is connected in series with a primary winding 162 of a load transformer 164. A secondary winding 166 of the load transformer 164 may have the load circuit 38 coupled thereacross. The primary winding 162 has a plurality of taps 172, 174, 176, 178 180 and 182 to select a proportion of voltage that will be contributed to the load transformer 164 output. Selection of a particular tap may be manual or in response to a voltage sensor and control circuit 184. Similarly, outputs from the additional sources 46 may be provided to a matching transformer 186. A waveform generator switch 156 may be provided to disconnect the output transformer 146 from the load transformer 164 when the waveform generator circuit 88 is not providing power. As further discussed with respect to FIG. 10 below, the waveform generator switch 156 may be controlled in response to an output from the battery voltage sensor 125. A switch 188 may be used to couple a secondary winding of the transformer 186 in series with the primary winding 162 of the load transformer 164 in order to couple power from the additional sources 46.

FIG. 8 is a waveform chart useful in understanding operation of the diversion circuit. In FIG. 8, the abscissa is time, and the ordinate is amplitude, each to an arbitrary scale. In FIG. 8a, the line current input waveform is illustrated. FIG. 8b represents a trigger voltage applied to the controlled switch 113 from the voltage sensor 116 (FIG. 5). FIG. 8c illustrates the “on” signal applied to the triac. FIG. 8d represents voltage applied to the charging circuit 74. When the input waveform reaches or exceeds the selected threshold level, 107 volts in the present illustration, the voltage sensor 116 produces a pulse to open the controlled switch 113. As seen in FIG. 8c, the controlled switch 113 turns off, and excess voltage is connected across the primary winding 104 as shown in FIG. 8d. Consequently, voltage is induced in the secondary winding 106, and is coupled to the charging circuit 74. When the input voltage decreases below the preselected threshold, the trigger signal is removed, and the controlled switch 113 again turns on so that the primary winding 104 is bypassed.

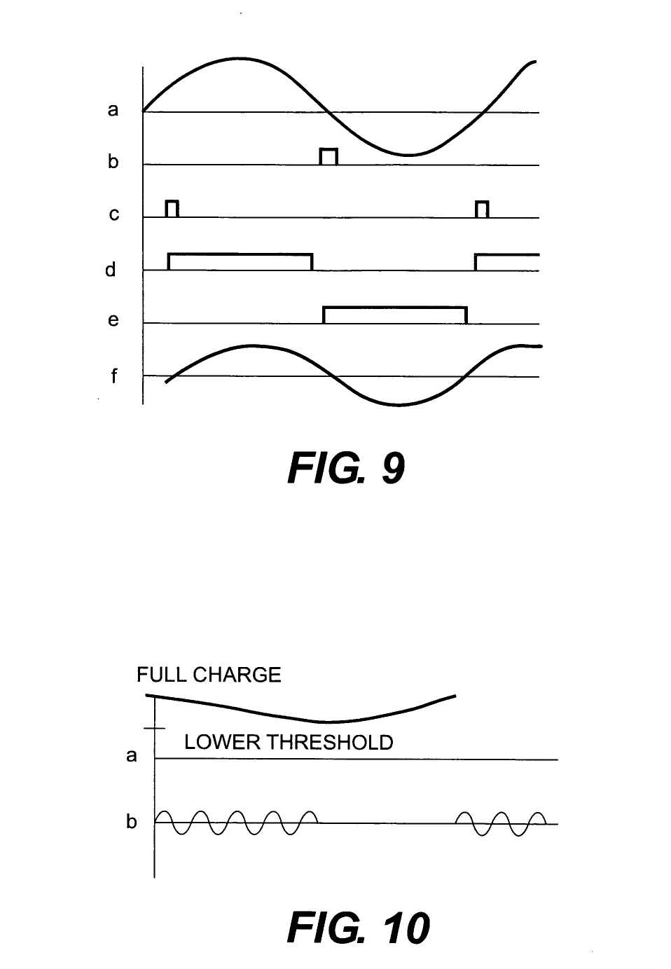

FIG. 9 is a waveform chart useful in understanding operation of the waveform generator 88. The abscissa is time, and in FIGS. 9a, b and d the ordinate is amplitude. In FIG. 9c the ordinate is on-off. The scales on both axes are arbitrary. A reference input waveform, namely the line current, is illustrated in FIG. 9a. The sensing signals produced by the wave sensor 132 (FIG. 7) at the first and second terminals 133 and 134 are illustrated in FIGS. 9b and 9c respectively. The on-off states of the transistors 140 and 142 are illustrated in FIGS. 9d and 9e respectively. The output waveform supplied by the waveform generator 88 is illustrated in FIG. 9f. As the line current reaches a zero crossing, from a negative going or positive going direction, outputs are produced by the wave sensor output 132 (FIGS. 9b and 9c). The switching circuit 130 reverses the polarity of the output. The conductive state of the transistors 140 and 142 toggles Consequently, polarity of the output of the waveform generator 88 is reversed. The waveform of FIG. 9f is generated. Reactive components, such as the inductances of the transformer 146, shape the switched DC output of the storage circuit 76 into a substantially sinusoidal waveform.

FIG. 10, consisting of FIGS. 10a and 10b, is a chart illustrating one form of a duty cycle for the translation circuit 90. FIGS. 10a and 10b respectively represent charge level of the battery bank 120 and voltage output of the translation circuit 90 (FIG. 7). The abscissa is time, and the ordinate is voltage, each on an arbitrary scale. Many different factors may be considered in deciding when to turn on the translation circuit 90 and when to turn it off. In the illustration of FIG. 10, the translation circuit 90 is activated to supply power when the battery bank 120 is fully charged, e.g., at 60 volts. The translation circuit 90 continues to supply power until the battery voltage goes below a threshold, e.g., 40 volts. Different switching points may be selected. Generally, it is undesirable to run a battery down to half voltage. Many forms of batteries are considered dead at this level. Different forms of batteries will have different optimizations of power supplied in an on-cycle, recharging time and other characteristics. As seen in FIG. 10a, voltage level of the battery bank 120 may initially provide power when the battery bank 120 is fully charged, e.g., at 60 volts. As the translation circuit 90 supplies power to the distribution interface 44, the voltage output of the battery bank 120 decreases. When the voltage level reaches a second level, e.g., 40 volts, supply of power from the storage circuit 76 is disabled. Operation may continue, with excess voltage charging the battery bank 120 until the voltage level reaches a voltage selected as indicating full charge, at which time supply of power from the translation circuit 90 is again enabled.

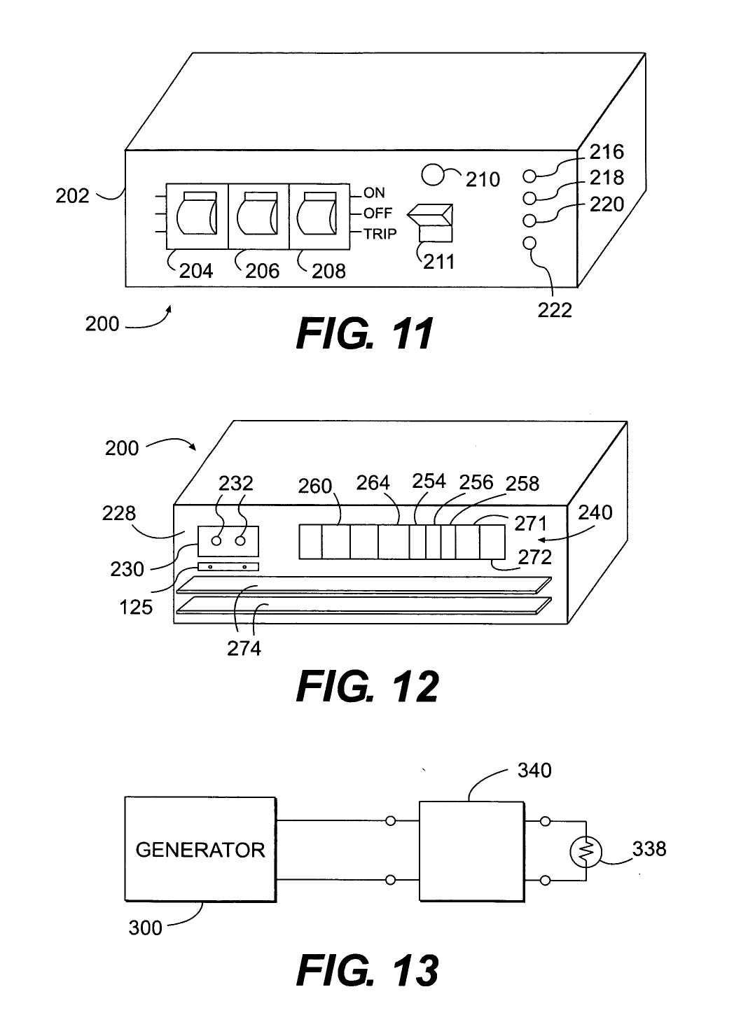

FIGS. 11 and 12 are front and rear elevations of housing 200 having a front panel 202. The housing 200 encloses a power system 40 (not shown). As seen in FIG. 11, circuit breakers 204, 206 and 208 are respectively connected to protect the power system 40, storage circuit 76 and waveform generator 88 (FIG. 3). The circuit breakers 204, 206 and 208 have switch controls located on the front panel 202. The circuit breakers 204, 206 and 208 are preferably of the type whose position, or state, is determined by visual inspection. The available states comprise On, Off and Tripped. The On position indicates that the respective circuit breaker 204, 206 or 208 is closed, the Off position indicates an open circuit, and the Tripped position indicates that the circuit breaker has been opened due to an overload. An indicator light 216 indicates that the waveform generator 88 is supplying power. An additional manual reset switch 211 may be provided to close all circuit breakers 204, 206 and 208. Further condition responsive indicators are preferably provided. The present embodiment comprises indicator lights 216, 218, 220 and 222. The indicator light 216 indicates whether input utility power is being provided. The indicator light 218 indicates that power is being supplied from the waveform generator 88. Indicator lights 220 and 222 indicate DC and AC overvoltages in respective AC or DC portions of the power system 40. However, the number of, and actual uses for, the indicator lights is dependent upon the desire of the user. The indicator lights exemplified herein are for illustrative purposes only and do not limit the present invention in any way.

As seen in FIG. 12, a rear panel 228 houses a fuse panel 230 including fuses 232. The fuses 232 may be used in circuits whose rated current is below that commonly served by circuit breakers. A terminal bank 240 includes the power terminal 260 and 264 for connection to the terminals 60 and 64 illustrated in FIG. 3 respectively. The terminal bank 240 may further include adjustment voltage output terminals 254, 256 and 258. Terminals 271 and 272 are provided for connection to the battery bank terminals 122+ and 122− respectively (FIG. 6). The battery voltage sensor 125 may also be mounted on the rear panel 228. In a preferred form, heat radiation fins 274 are mounted to the rear panel 228 in registration with heat producing components or subsystems in the interior of the housing 200.

FIG. 13 is a block diagram illustrating a further embodiment. This embodiment may be used in conjunction with a local generator 300. A power circuit 340, constructed in a manner similar to the power system 40 (FIG. 3) is utilized to increase current available from the generator in power provided to a load circuit 338. Rather than charging a storage circuit to decrease the amount of power drawn from the utility, power circuit 340 receives full operating power from the local generator 300 and adds additional available power to increase the current rating of the generator. In one non-limiting embodiment, a 10 KVA generator 300 has a maximum rated capacity of 54 amps. Use of a power circuit 340 increased maximum available current to 75 amps, and increased the power rating to 17 KVA.

The present subject matter being thus described, it will be apparent that the same may be modified or varied in many ways. Such modifications and variations are not to be regarded as a departure from the spirit and scope of the present subject matter, and all such modifications are intended to be included within the scope of the following claims.

What is claimed is:

1. An efficient power system supplying alternating current to a facility comprising:
a diversion circuit to receive line current from an alternating current utility line; said diversion circuit further comprising a supply to supply voltage to a load at a preselected nominal voltage and for resolving line voltage in excess of the preselected nominal voltage level to provide diverted line voltage;
a charging circuit;
a switching circuit having a threshold set as a function of the preselected nominal voltage level to couple the diverted line voltage to said charging circuit; and
a translation circuit to provide energy supplied by said charging circuit for combination with line voltage.

2. A power system according to claim 1, wherein said translation circuit comprises a storage circuit.

3. A power system according to claim 1, further comprising a distribution interface receiving power from said translation circuit and comprising means for selectively combining output power from said translation circuit with the line current.

4. A power system according to claim 3, further comprising a storage circuit coupled between said charging circuit and said distribution interface and wherein said distribution interface is coupled for selective provision of power to a grid.

5. A power system according to claim 4, wherein said translation circuit further comprises a waveform generator producing a wave, said waveform generator being supplied input power by said storage circuit and coupled to said output circuit.

6. A power system according to claim 5, wherein the storage circuit comprises a battery.

7. A power system according to claim 6, wherein said waveform generator comprises a DC to AC alternating wave generator having a circuit determining waveform frequency and wherein said circuit determining waveform frequency is coupled to be synchronized by the line current.

8. A power system according to claim 7, wherein said waveform generator comprises switching means to direct current through a transformer winding in alternate directions in successive half cycles and wherein said switching means comprises a sensor sensing line current to initiate switching in correspondence with successive half cycles of the line current.

9. A power system according to claim 1, wherein said supply to supply voltage to the load at a preselected nominal voltage comprises a voltage regulator.

10. A power system according to claim 8, wherein said supply to supply voltage to the load at a preselected nominal voltage comprises a voltage regulator.

11. A power system according to claim 10, further comprising a transformer having a primary winding coupled to diverted voltage and a secondary winding coupled to said charging circuit.

12. A power system according to claim 9 comprising a line voltage sensor and a controlled switch to conduct AC current, said sensor having a threshold set equal to the preselected nominal voltage, said sensor being connected to switch the conductive state when the line voltage is at least equal to the preselected threshold voltage and wherein the controlled switch is connected to couple the diverted voltage to said primary winding.

13. A power system according to claim 12, wherein said means for selectively combining output power from said translation circuit with line current in said translation means comprises a battery voltage sensor and a switch coupled to be controlled in response to battery voltage level, wherein said switch connects an output of the waveform generator in the distribution interface when battery voltage is at least a preselected threshold level and disconnects the output of the waveform generator when battery voltage is below the threshold.

14. A power system according to claim 13, wherein said distribution interface comprises a load transformer having a secondary winding for coupling to the load and a primary winding comprising a line voltage winding coupled across the line voltage and wherein said switch connecting an output of the waveform generator in the distribution interface comprises a switch selectively connecting a secondary winding of said waveform generator in series with said line voltage windings.

15. A power system according to claim 14, wherein said transformer comprises a matching transformer and further comprising a tap control circuit responsive to preselected voltage levels to provide a selected windings ratio in said output transformer.

16. A power system according to claim 10 further comprising a line charger for supply by line current and coupled to charge said battery and a control circuit to control operation of said line charger to provide for charging of the battery at a first selected time of day and discharging at a second time of day.

17. A power system according to claim 16, wherein said control circuit is programmed to charge said battery at off-peak hours and supply power to the grid at peak hours.

18. A method of operating a power system to efficiently use power from a utility comprising:
selecting a preselected nominal voltage level to be supplied for operation of a load;
monitoring a voltage level of line current supplied from a utility;
resolving line current into a first component comprising the nominal voltage and a second component comprising excess voltage;
diverting said excess voltage from being supplied to the load and coupling the excess voltage to charge a storage circuit;
storing energy in the charging circuit; and
selectively providing energy from said charging circuit for combination with power supplied to the load.

19. A method according to claim 18, wherein storing energy comprises charging a battery to a preselected level.

20. A method according to claim 19, wherein selectively providing energy comprises providing energy when a battery voltage level is at least at a preselected threshold.

21. A method according to claim 20, wherein providing energy comprises converting a DC output from the battery to an AC waveform and synchronizing the frequency of the AC waveform with frequency of line current.

22. A method according to claim 20, further charging the battery with a conventional charger and supplying power to a grid at selected times.

23. A method according to claim 20, wherein said power is combined in a transformer winding and further comprising adjusting transformer winding ratios to maintain desired secondary and primary voltages as selected power output are combined or removed from being supplied to the load.
